(19) United States
(12) Patent Application Publication
(10) Pub. No.: US 2001/0038574 A1
(43) Pub. Date: Nov. 8, 2001

(54) DEVICE FOR MIXING AT LEAST TWO LIQUIDS

(75) Inventors: ROBERT BOOS, DONAUESCHINGEN (DE); JURGEN FUNKHANEL, DONAUESCHINGEN (DE)

Correspondence Address: ROBERT W BECKER & ASSOCIATES, 11896 N HIGHWAY 14 SUITE B, TIJERAS, NM, 87059

(73) Assignee: ROBERT BOOS

(21) Appl. No.: 09/214,150

(22) PCT Filed: Jun. 18, 1997
(86) PCT No.: PCT/EP97/03176

§ 371 Date: None

(30) Foreign Application Priority Data
Jun. 26, 1996 (DE) P 196 25 651.8

(51) Int. Cl. B01F 15/02

(52) U.S. Cl. 366/147; 366/153.1; 366/173.1

(57) ABSTRACT

A device for mixing at least two liquids has a first container for metering the volume of a first liquid and a second container larger than the first container, wherein the first container is arranged in the second container. The second container is fillable with the first liquid and a second liquid.

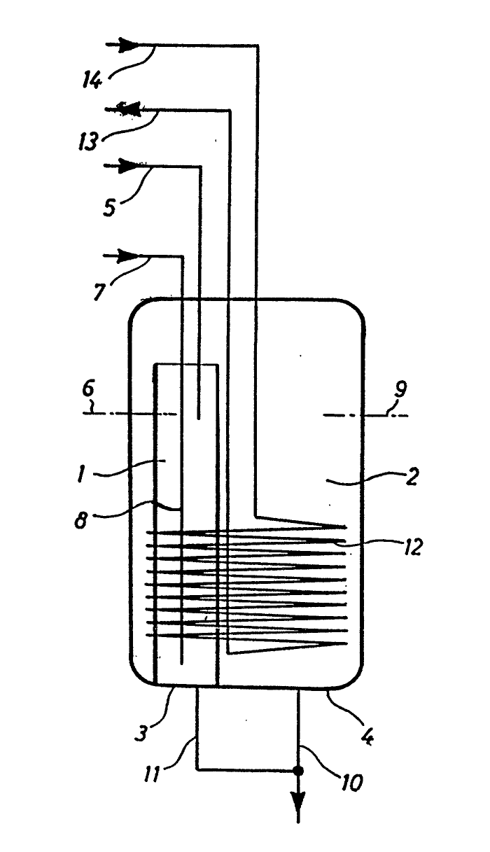

The invention relates to a device for mixing at least two liquids, comprising a first smaller container for a volumetric metering of a first liquid and a second larger container which can be filled with the first liquid and a second liquid.

In conventional devices of this kind the two containers are arranged adjacent to one another. The volume of the first liquid to be mixed with the second liquid is metered in a first smaller container and is subsequently fed into a second greater container in which the volume of the second liquid is added in a metered amount. Such a device requires a large space. Furthermore, a good mixing of the two liquids in the second greater container can only be achieved with additional measures, for example, stirring processes.

It is therefore an object of the invention to provide a mixing device for liquids which requires less space and/or allows for a good mixing of the liquids to be mixed.

Based on the aforementioned device, this object is inventively solved in that the first container is arranged within the second container. According to the invention the first container is thus integrated into the second container so that smaller dimensions of the mixing device are possible and, furthermore, longer tube connections between the first and second container are obsolete.

The first container can be inserted as an independent unit into the second container and fastened therein. For saving costs during manufacture it is, however, advantageous when the bottom area of the second container serves as the bottom of the first container. For providing the first container within the second container, according to this embodiment, it is only necessary to connect a cylinder, a rectangular tube, or a funnel-shaped tube to the bottom of the second container, for example, by welding. Thus, it is possible to save additional material from which the container must be manufactured and which must be of very high quality especially when aggressive liquids, for example, acids are used as the liquids to be mixed, as is the case in mixing devices in connection with treatment of wafers for the manufacture of semiconductor components and chips.

Advantageously, the first container and/or the second container comprise a lateral line for determining the filling level. Especially for the automated determination of the filling levels in connection with automatically controlled and governed mixing devices, at least one sensor is arranged within the lateral line for determining the filing level.

Especially with respect to measuring the liquid volume as exactly as possible especially of the first liquid of the smaller volume, it is advantageous when the ratio of height and width of the first container is large. The taller the container, the more exact the determination of the filling level. The height of the first container integrated into the second container thus expediently extends to the upper area of the second container.

Especially advantageous is an embodiment in which the first container in its cross-sectional area tapers downwardly, for example, is funnel-shaped in the downward direction. This allows in a simple manner a wide range of mixture metering and ratios.

According to an especially advantageous embodiment of the invention, the second liquid can be introduced via the first container into the second container, advantageously after volume metering of the first liquid within the first container. The second liquid thus is introduced via the first container until a predetermined filling amount is reached within the second container.

A further, very advantageous embodiment of the invention is characterized in that the second liquid, after volume metering of the first liquid within the first container, can be introduced into the lower portion of the first container. The first liquid is thus displaced within the first container by the second liquid so that the first liquid is forced from, and together with the second liquid, into the second container. In this context it is especially advantageous when an inlet tube, via which the second liquid is introduced into the first container, has an outlet, respectively, its end is within the lower area of the first container. The inlet tube extends then from above into the first container into the vicinity of the container bottom. Accordingly, inlet openings and tube connections at the first container are not required so that the manufacture is further simplified.

According to a further advantageous embodiment of the invention the first container is opened at its upper side and the first liquid enters, upon introduction of the second liquid, via the open upper side the second container.

After the first liquid has been forced by the second liquid across the open upper side into the second container, the second liquid is further introduced via the first container into the second container until the predescribed filling level in the second container has been reached so that in this manner only with this measure and without additional mixing elements a good mixing of the liquids to be mixed results.

Insofar as this is required or desirable, in and/or about the second container a temperature control device, for example, a cooling and/or a heating device, is provided, for example, in the form of tubes in which a cooling or heating liquid flows.

The invention will be explained in the following with the aid of preferred embodiments with the aid of the only schematic FIGURE.

As is shown in the FIGURE, a first smaller container 1 is contained within a second larger container 2. An area 3 of the bottom 4 of the second container 2 serves as the bottom for the first container 1.

Via a first inlet line 5 a first liquid to be mixed with a second liquid is introduced into the first container 1 until the desired volume of the first liquid is contained within the first container 1, i.e., until the first liquid has reached the filling level 6 of the first container 1. Then, the introduction of the first liquid is interrupted. Via a second inlet line 7 a second liquid is introduced into the first container 1. The inlet tube 8 of the second inlet line 7 entering the first container 1 extends into the lower area, i.e., into the vicinity of the bottom 3 of the first container 1. Upon introduction of the second liquid via the second inlet line 7 and the inlet tube 8 into the first container 1, the first liquid already contained within the first container 1 is forced upwardly and flows across the open upper side of the first container 1 into the second container 2. The second liquid flows then via the first container 1 into the second container until a predetermined filling level 9 of the second container 2 has been reached. Due to the displacement of the first liquid by the second liquid from the first container 1 into the second container 2 and the subsequent further introduction of the second liquid via the first container 1 also across its open upper side, a good uniform mixing of the two liquids to be mixed within the second container 2 takes place so that additional mixing elements are not required.

After completion of the mixing process, the mixed liquid is removed via outlet line 10 of the second container 2 to its designated use. The first container 1 comprises also an outlet line 11 via which the first container 1 can be emptied in order to allow a volume metering of the first liquid for a new mixing process within the container 1.

In the shown embodiment a cooling or heating coil 12 with inlet and outlet lines 12, 14 for the cooling or heating fluid are provided.

The inventive mixing device is preferably usable in connection with treatment tanks for wafer treatment. in such a use the first liquid is, for example, hydrofluoric acid and the second liquid deionized water. The filling and removing processes are performed automatically by determining the filling level with a sensor and with a control and adjusting system that controls the automatic operation of the mixing device.

The invention has been described with the aid of a preferred embodiment. However, to a person skilled in the art numerous deviations are obvious without deviating from the gist of the invention. For example, it is possible to provide in the second container 2 more than one further container 1 in order to mix more than two liquids in the inventive manner. A further possibility of use of the inventive principle is to provide in the first container I an additional container which is embodied according to the disclosed first container 1 so that a cascade-like mixing process results with which more than two liquids can be mixed.

What is claimed is:

1. Device for mixing at least two liquids, with a first, smaller container (1) for metering the volume of a first liquid and a second larger container (2) that can be filled with the first liquid and a second liquid, characterized in that the first container (1) is arranged within the second container (2).

2. Device according to claim 1, wherein a bottom area (3) of the second container (2) is the bottom of the first container (1).

3. Device according to claim 1 or 2, characterized in that at least one sensor (6, 9) is provided for determining the filling level at the first and/or second container (1 or 2).

4. Device according to one of the preceding claims, characterized in that the first and/or second container (1) respectively, (2) has a lateral line.

5. Device according to one of the preceding claims, characterized in that the ratio of height and width of the first container (1) is great.

6. Device according to one of the preceding claims, characterized in that the first container (1) has a downwardly tapering cross-sectional area.

7. Device according to claim 6, characterized in that the first container (1) is funnel-shaped.

8. Device according to one of the preceding claims, characterized in that the height of the first container (1) extends to the upper area of the second container (2).

9. Device according to one of the preceding claims, characterized in that the second liquid can be introduced via the first container (1) into the second container (2).

10. Device according to claim 9, characterized in that the second liquid, after volume of the first liquid within the first container (1), can be introduced into same.

11. Device according claim 9 or 10, characterized in that the second liquid, after volume metering of the first liquid in the first container (1), can be introduced into the lower area of the first container (1).

12. Device according to one of the preceding claims, characterized by an inlet tube (8) for the second liquid in the first container (1) which has its exit in the lower area of the first container (1).

13. Device according one of the preceding claims, characterized in that the first container (1) is open at its upper side.

14. Device according to claim 11, characterized in that the first liquid upon introduction of the second liquid into the first container (1) can be forced via the open upper side into the second container (2).

15. Device according one of the preceding claims, characterized in that in and/or at the second container (2) a temperature control device is provided.

16. A device for mixing at least two liquids, said device comprising:
a first container (1) for metering the volume of a first liquid;
a second container (2) larger than said first container (1), wherein said first container 91) is arranged in said second container (2);
said second container (2) fillable with said first liquid and a second liquid.

17. A device according to claim 16, wherein said second container (2) has a bottom area (3) and wherein said bottom area (3) is the bottom of said first container (1).

18. A device according to claim 16, further comprising at least one sensor (6, 9) for determining a filling level of said first container (1).

19. A device according to claim 16, further comprising at least one sensor (6, 9) for determining a filling level of said second container (1).

20. A device according to claim 16, further comprising at least one sensor (6, 9) for determining a filling level of said first and second containers (1, 2).

21. A device according to claim 16, wherein said first container (1) has a lateral line.

22. A device according to claim 16, wherein said second container (2) has a lateral line.

23. A device according to claim 16, wherein said first and second containers (1, 2) have a lateral line.

24. A device according to claim 16, wherein a ratio of height to width of said first container (1) is great.

25. A device according to claim 16, wherein said first container (1) has a downwardly tapering cross-sectional area.

26. A device according to claim 16, wherein said first container (1) is funnel-shaped.

27. A device according to claim 16, wherein said first container (1) has an upper end positioned in an upper area of said second container (2).

28. A device according to claim 16, wherein said second liquid can be introduced via said first container (1) into said second container (2).

29. A device according to claim 16, wherein said second liquid, after volume metering of said first liquid within said first container (1), is introduced into said first container (1).

30. A device according claim 16, wherein said second liquid, after volume metering of said first liquid in said first container (1), is introduced into the lower area of said first container (1).

31. A device according to claim 16, wherein said first container (1) has an inlet tube (8) for said second liquid, wherein said inlet tube (8) opens into the lower area of said first container (1).

32. A device according to claim 16 wherein said first container (1) has an upper side that is open.

33. A device according to claim 32, wherein said first liquid, upon introduction of said second liquid into said first container (1), is forced via said open upper side into said second container (2).

34. A device according to claim 16, wherein said second container (2) comprises a temperature control device.
